(19) United States
(12) Patent Application Publication
(10) Pub. No.: US 2018/0091631 A1
(43) Pub. Date: Mar. 29, 2018

(54) SYSTEMS AND METHODS FOR WRITING PRIORITIZED HTTP/2 DATA TO A SOCKET BUFFER

(71) Applicant: Akamai Technologies, Inc., Cambridge, MA (US)

(72) Inventors: Christopher R. Dumoulin, Ottawa (CA); Edward T. Dao, San Jose, CA (US); Wenkai Wang, San Jose, CA (US)

(73) Assignee: Akamai Technologies, Inc., Cambridge, MA (US)

(21) Appl. No.: 15/829,533

(22) Filed: Dec. 1, 2017

Related U.S. Application Data
(60) Provisional application No. 62/540,417, filed on Aug. 2, 2017.

(51) Int. Cl. H04L 29/06; H04L 12/835; H04L 12/925; H04L 12/863; H04L 12/801

(52) U.S. Cl. CPC H04L 69/162; H04L 47/30; H04L 69/329; H04L 47/623; H04L 47/193; H04L 47/722

(57) ABSTRACT

This patent document describes, among other things, improved methods and systems for managing H2 data writes to a socket in the context of prioritized HTTP v2 (“H2”) streams. Properly respecting the different priorities of H2 streams is important. The techniques described herein make intelligent write scheduling decisions based on the state of the TCP connection (e.g., congestion window), socket buffer state, on the type of web resource being sent, and other factors.

### CROSS REFERENCE TO RELATED APPLICATION

This application is based on and claims the benefit of priority of U.S. Provisional Application No. 62/540,417, filed Aug. 2, 2017, the teachings of which are hereby incorporated by reference.

### BACKGROUND

### Technical Field

This application relates generally to data processing systems, web servers, and to the delivery of web content to users over computer networks.

### Brief Description of the Related Art

Hypertext Transfer Protocol (HTTP) is a well-known application layer protocol. It is used for transporting HTML documents that define the presentation of web pages, as well as embedded resources in such pages. The HTTP 1.0 and 1.1 standards came about in the 1990s. Recently, HTTP 2.0, a major revision to HTTP, has been approved for standards track consideration by the WIT (RFC 7540), The HTTP 2.0 proposed standard has been in development for some time (see, e.g., HTTP version 2, working draft, draft-ietf-httpbis-http2-16, Nov. 29, 2014).

Among other things, HTTP 2.0 (“H2”) enables efficient use of network resources and a reduced perception of latency by enabling header field compression, server push, and multiplexing streams (equivalent to a request in HTTP 1.1) on a single TCP connection. There are number of concepts that are introduced in the H2 specification to make this transition from multiple TCP connections to a single TCP connection possible without loss of performance. One such concept is the ability of a client to send ‘hints’ indicating the importance of a given stream (in other words, the stream's priority) relative to other streams on the same connection. This priority setting enables resources to be allocated appropriately. In addition to traditional numerical priority weight, an H2 stream can also indicate the notion of dependencies. Dependencies indicate that certain streams are dependent upon the completion of their parent stream(s). The combination of priority weight and dependency can be used to determine a priority for a stream. For more information, see blogs<dot>akamai<dot>com/2016/04/http2-enables-more-intelligent-resource-loading-via-stream-dependencies-but-its-not-as-simple-as-you<dot>html

While in theory H2 stream prioritization should improve key resource delivery and thus page loading times, in practice this is not always the case. This lack of improvement is because the stream priorities managed by H2 do not operate in a vacuum; rather, a web server writes H2 data to a socket buffer, which is managed by an operating system kernel. The TCP/IP stack in the kernel is tasked with emptying the queue and delivering the data to the network; however there are many sockets competing for bandwidth and moreover the TCP layer (or other transport layer) typically throttles data delivery in accordance with flow control and congestion avoidance algorithms, of which many variants are known in the art.

Examples of problems include (1) a server push of resources (such as JS, CSS, images) before delivering the base page HTML causing an increase in time to first byte (TTFB) for HTM, (2) other (non-HTML) high priority resources, such as CSS files, competing for bandwidth with lower priority resources, despite that the relative priorities of the different streams should have meant that this contention wouldn't exist.

The desired behavior is that as soon as high priority data is received in a web server, it can be delivered to the client immediately, without waiting in the socket buffer behind other lower priority data. At the same time throughput should be maintained.

The interplay between application layer priority, socket buffers, and transport layer algorithms has been explored in the context of T or systems. See, for example, Jansen et al., Never Been KIST: Tor's Congestion Management Blossoms with Kernel-Informed Socket Transport, Proceedings of the 23rd USENIX Security Symposium, Aug. 20-22, 2014, San Diego, Calif., USA, pages 127-142, ISBN 978-1-931971-15-7. Like H2, Tor offers a facility for designating priority of data to be sent. Jansen et al. describe how Tor fails to respect those priorities in certain cases because of issues similar to those described above for H2. Hence, Jansen et al. describe a technique for managing the socket buffer to improve control over priority. Their solution, which they call KIST (kernel-informed socket transport), includes a new socket management algorithm that uses real-time kernel information, and in particular TCP state information, to dynamically compute the amount to write to each socket. (Abstract; pages 133-136.)

The teachings hereof represent an extension of Jansen's ideas to the H2 context. The teachings hereof can be used to improve the efficiency of web page loading and of network usage, as well as improving adherence to H2 priority assignments.

### BRIEF DESCRIPTION OF THE DRAWINGS

The invention will be more fully understood from the following detailed description taken in conjunction with the accompanying drawings, in which:

FIG. 1 is a schematic diagram illustrating one embodiment of a known distributed computer system configured as a content delivery network;

FIG. 2 is a schematic diagram illustrating one embodiment of a machine on which a CDN server in the system of FIG. 1 can be implemented;

FIG. 3 is a schematic diagram illustrating one embodiment of a general architecture for a WAN optimized, “behind-the-firewall” service offering;

FIG. 4 is a block diagram illustrating hardware in a computer system that may be used to implement the teachings hereof.

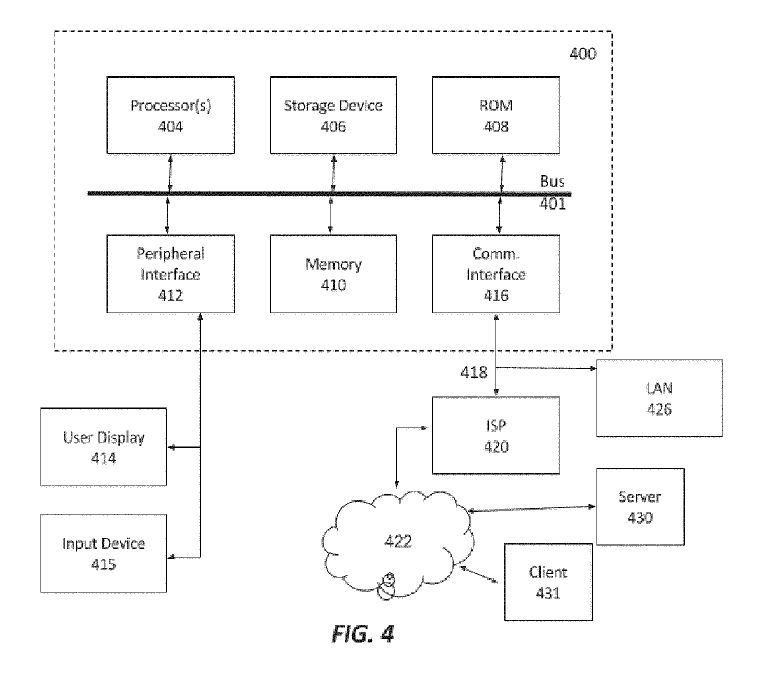

### DETAILED DESCRIPTION

The following description sets forth embodiments of the invention to provide an overall understanding of the principles of the structure, function, manufacture, and use of the methods and apparatus disclosed herein. The systems, methods and apparatus described herein and illustrated in the accompanying drawings are non-limiting examples; the claims alone define the scope of protection that is sought. It is contemplated that implementations of the teachings hereof will vary with design goals, performance desires and later developments, without departing from the teachings hereof. The features described or illustrated in connection with one exemplary embodiment may be combined with the features of other embodiments. Such modifications and variations are intended to he included within the scope of the present invention. All patents, publications and references cited herein are expressly incorporated herein by reference in their entirety.

Throughout this disclosure, the term “e.g.” is used as an abbreviation for the non-limiting phrase “for example,” Basic familiarity with well-known web page and networking technologies and terms, such as HTML, URL, XML, AJAX, CSS, HTTP versions 1.1 and 2, and TCP/IP, is assumed. In this disclosure, the terms page ‘object’ and page ‘resource’ are used interchangeably with no intended difference in meaning. The term base page is used herein to refer to page defined by an associated markup language document (e.g., HTML) that references one or more embedded resources (e.g., images, CSS, Javascript, or other types), as known in the art. The term “server” is used herein to refer to hardware (a computer configured as a server, also referred to as a “server machine”) with server software running on such hardware (e.g., a web server). While context may indicate the hardware or the software exclusively, should such distinction be appropriate, the teachings hereof can be implemented in any combination of hardware and software.

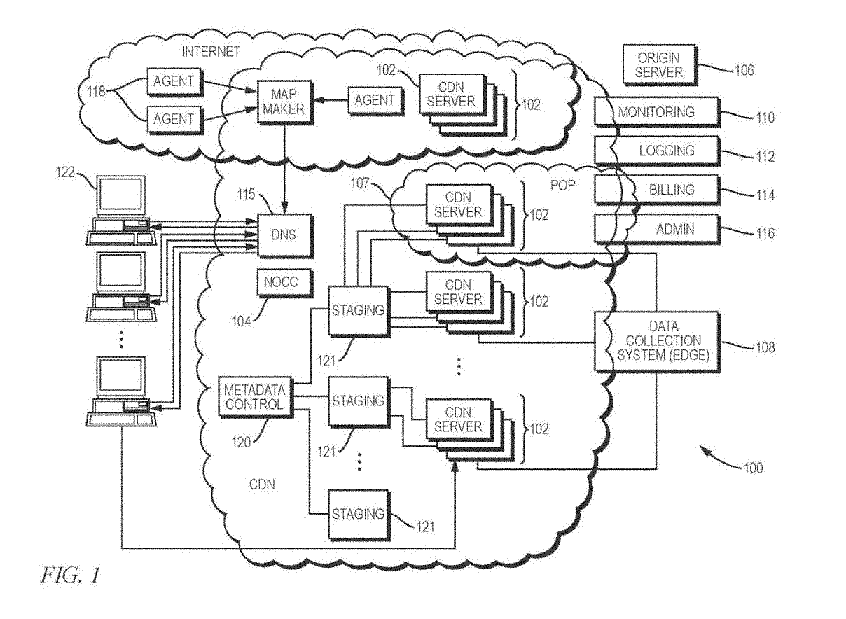

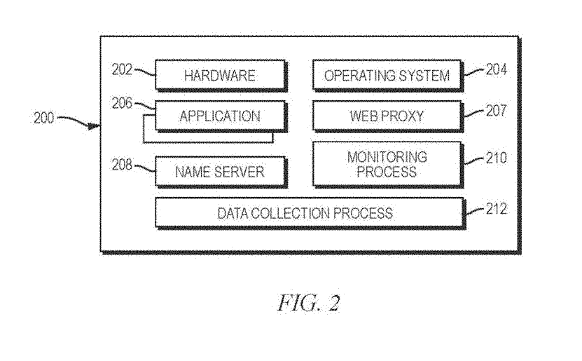

The teachings hereof may be implemented in a web server and in particular in a CDN server 102, 200 of the type described with respect to FIGS. 1 and 2. The system calls described below assume a Linux operating system with a kernel providing conventional TCP/IP functions, as known in the art.

Overview

The following is a high-level description of changes that can be made in writing H2 frames to a socket, according to the teachings hereof.

As mentioned above, properly respecting the different priorities of H2 streams is important. TCP congestion control and flow control limit how much sent data can be in flight (un-ACKed). However, the socket buffer can hold much more than the in-flight data. This excess data will sit in the socket buffer waiting to be sent, and cannot be re-ordered if higher priority arrives.

To be responsive to the arrival of high priority data, 1-12 frames should be held in user space (where they can be re-ordered) until it is known that the data will be sent out immediately when it is written to the socket buffer. This responsiveness needs to be balanced with maintaining a high level of throughput.

A proposed writing algorithm makes decisions based on the state of the TCP connection. It looks at the congestion window size (CWND) and the number of un-ACKed packets to determine how much space is available in the congestion window. It also monitors the amount of unseat data in the socket buffer.

Socket Writing Algorithm Details

Stream Priorities

Assume that a web server application has a set of multiple H2 streams assigned different relative priorities to serve to a client. As response data arrives to the socket writer for different streams it is placed in a priority queue ordered according to stream priority, in the form of H2 frames. The writing algorithm controls the amount of data that is taken from the priority queue and written to the socket buffer while it is waiting for data from the highest priority stream to arrive. Any time the frames at the front of the priority queue are for the highest priority open stream, relative to other open streams, those frames are popped from the queue and written to the socket buffer, without limit, until the socket buffer is full.

Determining TCP State

The amount of data to write to the socket buffer is preferably determined based on the TCP state, For example, a kernel call to getsockopt(TCP_INFO) gives us the TCP CWND size (tcpi_snd_cwnd), the number of un-ACKed sent packets (tcpi_unacked), and the TCP MSS (tcpi_snd_mss).

Doing the subtraction (tcpi_snd_cwnd minus tcpi_unacked) gives the available space in the TCP congestion window, in packets. Multiplying by tcpi_snd_msss gives the available space in bytes.

Any time the algorithm ends up with more than the congestion window size in the socket buffer (tcpi_snd_cwnd minus tcpi_unacked=0), or if it were to write more than the client receive window, there will be unsent data sitting in the socket buffer. The condition of the buffer is monitored using a system call to ioctl(SIOCOUTQNSD), which returns the number of unsent bytes.

Algorithm for Prioritizing HTML

When loading a web page the HTML itself is the highest priority resource. This is because other resources won't be discovered by the client browser until the HTML is processed, and even resources pushed before the HTML is delivered won't be processed until the associated part of the HTML has been processed. It's also relevant to note that HTML is processed by the browser in a streaming fashion and the most important resources are usually referenced near the beginning. All of this means that time to first byte (TTFB) for HTML is extremely important.

When doing a web server push of non-HTML resources (JS, CSS, images), before the base page HTML has been delivered, the algorithm writes data for lower priority streams, but reserves space in the TCP congestion window for the HTML. This reserved space is preferably specified in packets, and is configurable. Having this reserved space means that once the HTML data arrives at least some of it can be written to the wire immediately. A good configurable size could be derived from testing and/or estimated HTML sizes based on the URL or customer's previously-delivered pages.

Note that the foregoing techniques apply equally well to other markup language documents.

Algorithm for Other (non-HTML) high priority streams

Once the base page HTML has been delivered, some other stream will be the highest priority open stream. Often this will be a high priority CSS file, or in some cases Javascript. It's still important to be responsive to these other high priority streams. CSS and Javascript aren't processed by browsers in a streaming manner, so time to last byte (TTLB) is more important than time to first byte (TTFB). In this case, the algorithm will not reserve space in the TCP congestion window, so the buffer can fill up with lower priority data. But, the algorithm also monitors the congestion window state and avoids writing to the socket buffer more than the congestion window size. This means the algorithm aims to have no unsent data sitting in the socket buffer while waiting for the highest priority open stream. As a result, once the high priority data arrives it will have to wait at most 1 round trip time for an TCP ACK to arrive and space to be available in the congestion window.

Use In Content Delivery Networks

As mentioned above, the teachings hereof can be used in a web server, and a content delivery network can provide a suitable distributed set of web servers. What follows is a description of a content delivery network, at least in one embodiment.

One type of distributed computer system is a “content delivery network” or “CDN” that is operated and managed by a service provider. The service provider typically provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. This infrastructure is shared by multiple tenants, the content providers. The infrastructure is generally used for the storage, caching, or transmission of content—such as web pages, streaming media and applications on behalf of such content providers or other tenants. The platform may also provide ancillary technologies used therewith including, without limitation, DNS query handling, provisioning, data monitoring and reporting, content targeting, personalization, and business intelligence.

In a known system such as that shown in FIG. 1, a distributed computer system 100 is configured as a content delivery network (CDN) and has a set of servers 102 distributed around the Internet. Typically, most of the servers are located near the edge of the Internet, i.e., at or adjacent end user access networks. A network operations command center (NOCC) 104 may be used to administer and manage operations of the various machines in the system. Third party sites affiliated with content providers, such as web site 106, offload delivery of content (e.g., HTML or other markup language files, embedded page objects, streaming media, software downloads, and the like) to the distributed computer system 100 and, in particular, to the CDN servers (which are sometimes referred to as content servers, or sometimes as “edge” servers in light of the possibility that they are near an “edge” of the Internet). Such CDN servers 102. may be grouped together into a point of presence (POP) 107 at a particular geographic location.

The CDN servers are typically located at nodes that are publicly-routable on the Internet, in end-user access networks, peering points, within or adjacent nodes that are located in mobile networks, in or adjacent enterprise-based private networks, or in any combination thereof.

Typically, content providers offload their content delivery by aliasing (e.g., by a DNSCNAME) given content provider domains or sub-domains to domains that are managed by the service provider's authoritative domain name service. The server provider's domain name service directs end user client machines 122 that desire content to the distributed computer system (or more particularly, to one of the CDN servers in the platform) to obtain the content more reliably and efficiently. The CDN servers respond to the client requests, for example by fetching requested content from a local cache, from another CDN server, from an origin server 106 associated with the content provider, or other source, and sending it to the requesting client.

For cacheable content, CDN servers typically employ a caching model that relies on setting a time-to-live (TTL) for each cacheable object. After it is fetched, the object may be stored locally at a given CDN server until the TTL expires, at which time is typically re-validated or refreshed from the origin server 106. For non-cacheable objects (sometimes referred to as ‘dynamic’ content), the CDN server typically returns to the origin server 106 when the object is requested by a client. The CDN may operate a server cache hierarchy to provide intermediate caching of customer content in various CDN servers that are between the CDN server handling a client request and the origin server 106; one such cache hierarchy subsystem is described in U.S. Pat. No. 7,376,716, the disclosure of which is incorporated herein by reference.

Although not shown in detail in FIG. 1, the distributed computer system may also include other infrastructure, such as a distributed data collection system 108 that collects usage and other data from the CDN servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115. A distributed data transport mechanism 120 may be used to distribute control information (e.g., metadata to manage content, to facilitate load balancing, and the like) to the CDN servers. The CDN may include a network storage subsystem (sometimes referred to herein as “NetStorage”) which may be located in a network datacenter accessible to the CDN servers and which may act as a source of content, such as described in U.S. Pat. No. 7,472,178, the disclosure of which is incorporated herein by reference.

As illustrated in FIG. 2, a given machine 200 in the CDN comprises commodity hardware (e.g., a microprocessor) 202 running an operating system kernel (such as Linux® or variant) 204 that supports one or more applications 206a-n. To facilitate content delivery services, for example, given machines typically run a set of applications, such as an HTTP proxy server 207, a name service 208, a local monitoring process 210, a distributed data collection process 212, and the like. The HTTP proxy server 207 (sometimes referred to herein as a HTTP proxy for short) is a kind of web server and it typically includes a manager process for managing a cache and delivery of content from the machine. For streaming media, the machine may include one or more media servers, as required by the supported media formats.

A given CDN server 102 seen in FIG. 1 may be configured to provide one or more extended content delivery features, preferably on a domain-specific, content-provider-specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism. U.S. Pat. No. 7,240,100, the contents of which are hereby incorporated by reference, describe a useful infrastructure for delivering and managing CDN server content control information, and this and other control information (sometimes referred to as “metadata”) can be provisioned by the CDN service provider itself, or (via an extranet or the like) the content provider customer who operates the origin server. U.S. Pat. No. 7,111,057, incorporated herein by reference, describes an architecture for purging content from the CDN. More information about a CDN platform can be found in U.S. Pat. Nos. 6,108,703 and 7,596,619, the teachings of which are hereby incorporated by reference in their entirety.

In a typical operation, a content provider identifies a content provider domain or sub-domain that it desires to have served by the CDN. When a DNS query to the content provider domain or sub-domain is received at the content provider's domain name servers, those servers respond by returning the CDN hostname (e.g., via a canonical name, or CNAME, or other aliasing technique). That network hostname points to the CDN, and that hostname is then resolved through the CDN name service. To that end, the CDN name service returns one or more IP addresses. The requesting client application (e.g., browser) then makes a content request (e.g., via HTTP or HTTPS) to a CDN server machine associated with the IP address. The request includes a host header that includes the original content provider domain or sub-domain. Upon receipt of the request with the host header, the CDN server checks its configuration file to determine whether the content domain or sub-domain requested is actually being handled by the CDN. If so, the CDN server applies its content handling rules and directives for that domain or sub-domain as specified in the configuration. These content handling rules and directives may be located within an XML-based “metadata” configuration file, as mentioned previously.

The CDN platform may be considered an overlay across the Internet on which communication efficiency can be improved. Improved communications techniques on the overlay can help when a CDN server needs to obtain content from origin server 106, or otherwise when accelerating non-cacheable content for a content provider customer. Communications between CDN servers and/or across the overlay may be enhanced or improved using improved route selection, protocol optimizations including TCP enhancements, persistent connection reuse and pooling, content & header compression and de-duplication, and other techniques such as those described in U.S. Pat. Nos. 6,820,133, 7,274,658, 7,607,062, and 7,660,296, among others, the disclosures of which are incorporated herein by reference.

As an overlay offering communication enhancements and acceleration, the CDN server resources may be used to facilitate wide area network (WAN) acceleration services between enterprise data centers and/or between branch-headquarter offices (which may be privately managed), as well as to/from third party software-as-a-service (SaaS) providers used by the enterprise users.

In this vein CDN customers may subscribe to a “behind the firewall” managed service product to accelerate Intranet web applications that are hosted behind the customer's enterprise firewall, as well as to accelerate web applications that bridge between their users behind the firewall to an application hosted in the Internet cloud (e.g., from a SaaS provider).

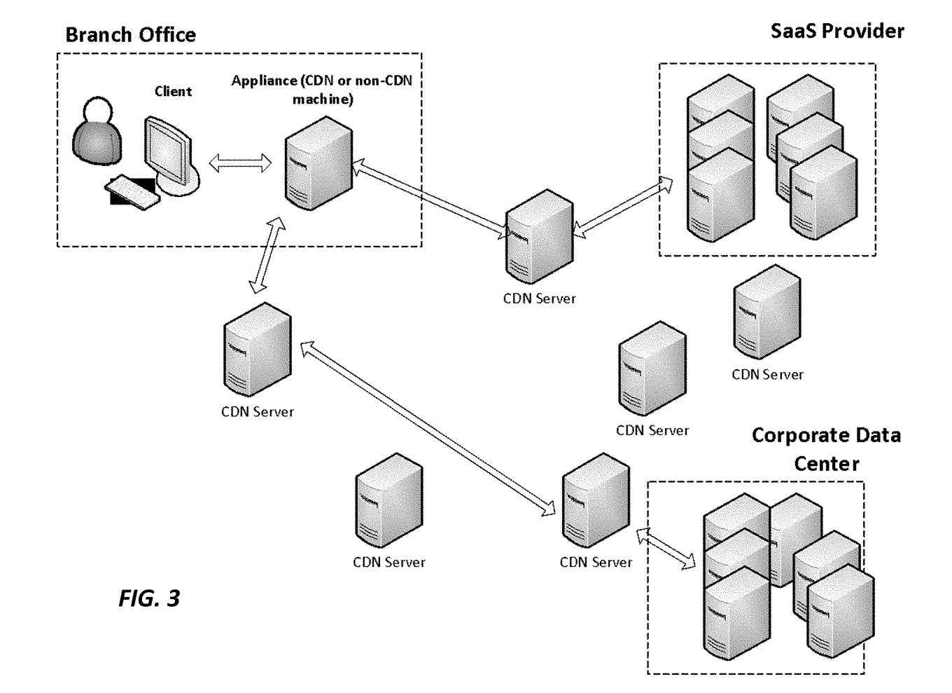

To accomplish these two use cases, CDN software may execute on machines (potentially in virtual machines running on customer hardware) hosted in one or more customer data centers, and on machines hosted in remote “branch offices.” The CDN software executing in the customer data center typically provides service configuration, service management, service reporting, remote management access, customer SSL/TLS certificate management, as well as other functions for configured web applications. The software executing in the branch offices provides last mile web acceleration for users located there. The CDN itself typically provides CDN hardware hosted in CDN data centers to provide a gateway between the nodes running behind the customer firewall and the CDN service provider's other infrastructure (e.g., network and operations facilities). This type of managed solution provides an enterprise with the opportunity to take advantage of CDN technologies with respect to their company's intranet, providing a wide-area-network optimization solution. This kind of solution extends acceleration for the enterprise to applications served anywhere on the Internet. By bridging an enterprise's CDN-based private overlay network with the existing CDN public internet overlay network, an end user at a remote branch office obtains an accelerated application end-to-end. FIG. 3 illustrates a general architecture for a WAN optimized, “behind-the-firewall” service offering such as that described above; assume in FIG. 3 that the CDN servers placed around the Internet between the brand office, SaaS provider, and corporate data center. Information about a behind the firewall service offering can be found in teachings of U.S. Pat. No. 7,600,025, the teachings of which are hereby incorporated by reference.

For live streaming delivery, the CDN may include a live delivery subsystem, such as described in U.S. Pat. No. 7,296,082, and U.S. Publication Nos. 2011/0173345 and 2012/0265853, the disclosures of which are incorporated herein by reference.

Computer Based Implementation

The subject matter described herein may be implemented with computer systems, as modified by the teachings hereof, with the processes and functional characteristics described herein realized in special-purpose hardware, general-purpose hardware configured by software stored therein for special purposes, or a combination thereof.

Software may include one or several discrete programs. A given function may comprise part of any given module, process, execution thread, or other such programming construct. Generalizing, each function described above may be implemented as computer code, namely, as a set of computer instructions, executable in one or more microprocessors to provide a special purpose machine. The code may be executed using conventional apparatus—such as a microprocessor in a computer, digital data processing device, or other computing apparatus as modified by the teachings hereof. In one embodiment, such software may be implemented in a programming language that runs in conjunction with a proxy on a standard Intel hardware platform running an operating system such as Linux. The functionality may he built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

FIG. 5 is a block diagram that illustrates hardware in a computer system 500 on which embodiments of the invention may be implemented. The computer system 500 may be embodied in a client device, server, personal computer, workstation, tablet computer, wireless device, mobile device, network device, router, hub, gateway, or other device.

Computer system 500 includes a microprocessor 504 coupled to bus 501. In some systems, multiple microprocessor and/or microprocessor cores may be employed. Computer system 500 further includes a main memory 510, such as a random access memory (RAM) or other storage device, coupled to the bus 501 for storing information and instructions to be executed by microprocessor 504. A read only memory (ROM) 508 is coupled to the bus 501 for storing information and instructions for microprocessor 504. As another form of memory, a non-volatile storage device 506, such as a magnetic disk, solid state memory (e.g., flash memory), or optical disk, is provided and coupled to bus 501 for storing information and instructions. Other application-specific integrated circuits (ASICs), field programmable gate arrays (FPGAs) or circuitry may be included in the computer system 500 to perform functions described herein.

Although the computer system 500 is often managed remotely via a communication interface 516, for local administration purposes the system 500 may have a peripheral interface 512 communicatively couples computer system 500 to a user display 514 that displays the output of software executing on the computer system, and an input device 515 (e.g., a keyboard, mouse, trackpad, touchscreen) that communicates user input and instructions to the computer system 500. The peripheral interface 512 may include interface circuitry and logic for local buses such as Universal Serial Bus (USB) or other communication links.

Computer system 500 is coupled to a communication interface 516 that provides a link between the system bus 501 and an external communication link. The communication interface 516 provides a network link 518. The communication interface 516 may represent an Ethernet or other network interface card (NIC), a wireless interface, modem, an optical interface, or other kind of input/output interface.

Network link 518 provides data communication through one or more networks to other devices. Such devices include other computer systems that are part of a local area network (LAN) 526. Furthermore, the network link 518 provides a link, via an internet service provider (ISP) 520, to the Internet 522. In turn, the Internet 522 may provide a link to other computing systems such as a remote server 530 and/or a remote client 531. Network link 518 and such networks may transmit data using packet-switched, circuit-switched, or other data-transmission approaches.

In operation, the computer system 500 may implement the functionality described herein as a result of the microprocessor executing program code. Such code may be read from or stored on memory 510, ROM 508, or non-volatile storage device 506, which may be implemented in the form of disks, tapes, magnetic media, CD-ROMs, optical media, RAM, PROM, EPROM, and EEPROM. Any other non-transitory computer-readable medium may be employed. Executing code may also be read from network link 518 (e.g., following storage in an interface buffer, local memory, or other circuitry).

A client device may be a conventional desktop, laptop or other Internet-accessible machine running a web browser or other rendering engine, but as mentioned above a client may also be a mobile device. Any wireless client device may be utilized, e.g., a cellphone, pager, a personal digital assistant (PDA, e.g., with GPRS NIC), a mobile computer with a smartphone client, tablet or the like. Other mobile devices in which the technique may be practiced include any access protocol-enabled device (e.g., iOS™-based device, an Android™-based device, other mobile-OS based device, or the like) that is capable of sending and receiving data in a wireless manner using a wireless protocol. Typical wireless protocols include: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP. The WAP (wireless access protocol) also provides a set of network communication layers (e.g., WDP, WTLS, WTP) and corresponding functionality used with GSM and CDMA wireless networks, among others.

In a representative embodiment, a mobile device is a cellular telephone that operates over GPRS (General Packet Radio Service), which is a data technology for GSM networks. Generalizing, a mobile device as used herein is a 3G-(or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The teachings disclosed herein are not limited to any particular mode or application layer for mobile device communications.

It should be understood that the foregoing has presented certain embodiments of the invention that should not be construed as limiting. For example, certain language, syntax, and instructions have been presented above for illustrative purposes, and they should not he construed as limiting. It is contemplated that those skilled in the art will recognize other possible implementations in view of this disclosure and in accordance with its scope and spirit. The appended claims define the subject matter for which protection is sought.

It is noted that trademarks appearing herein are the property of their respective owners and used for identification and descriptive purposes only, given the nature of the subject matter at issue, and not to imply endorsement or affiliation in any way.

1. A method performed by a computer, the computer having circuitry forming one or more processors and memory holding instructions for execution on the one or more processors to provide a write scheduling module that performs a method for writing data to a socket buffer, the method comprising:
receiving one or more prioritized H2 streams from an HTTP server application for transmission to a client device;
monitoring the fill state of a socket buffer associated with a transport layer connection, to the client device, the transport layer connection being a TCP connection;
monitoring the TCP state of the TCP connection, the TCP state including the status of the congestion window;
managing socket writing of the prioritized H2 streams based at least n part on the fill state of the socket buffer and the TCP state.

2. The method of claim 1, wherein said managing comprises reserving space in the socket buffer for an HTML document, until the HTML document is sent.

3. The method of claim 1, wherein said managing comprises writing only as much data as is available in the congestion window, in advance of delivering the highest priority stream, so that the highest priority stream can be sent more quickly from the socket buffer.

4. The method of claim 3, further comprising, when data for the highest priority stream at a given time is available from an application, writing that data to the socket buffer without restriction related to the congestion window state.

5. The method of claim 3, wherein said managing applies only to non-highest priority streams.

6. The method of claim 3, wherein the highest priority stream at a given time is a stream carrying one of HTML, CSS, and Javascript.

7. The method of claim 3, where the priority of a stream is determined based on stream weight and dependency information.
